(19) United States
(12) Patent Application Publication
(10) Pub. No.: US 2025/0329837 A1
(43) Pub. Date: Oct. 23, 2025

(54) ELECTRONIC DEVICE HOUSING HAVING RECYCLED POLYMER, AND ELECTRONIC DEVICE COMPRISING SAME

(71) Applicant: SAMSUNG ELECTRONICS CO., LTD., Suwon-si (KR)

(72) Inventors: Hangyu HWANG, Suwon-si (KR); Namhyun KIM, Seoul (KR); Taegon KANG, Seoul (KR); Euntaek WOO, Seoul (KR); Pranveer Singh RATHORE, Suwon-si (KR); Bongjoon KIM, Suwon-si (KR); Horim YU, Suwon-si (KR); Changsu KIM, Suwon-si (KR); Sangsik NA, Suwon-si (KR)

(21) Appl. No.: 19/258,832

(22) Filed: Jul. 2, 2025

Related U.S. Application Data
(63) Continuation of application No. PCT/KR2024/095252, filed on Feb. 16, 2024.

(30) Foreign Application Priority Data
Feb. 16, 2023 (KR) 10-2023-0021006

(51) Int. Cl. H01M 50/227; C08K 3/32; C08K 7/14; C08L 69/00; H01M 50/291

(52) U.S. Cl. CPC H01M 50/227; H01M 50/291; C08K 3/32; C08K 2003/329; C08K 7/14; C08L 69/00

(57) ABSTRACT

An electronic device according to an embodiment of the present invention includes a display and a housing, where the housing includes: an outer frame which includes a polymer material, which forms at least a part of the outer surface of the housing, and which is positioned to protect at least a part of the outer perimeter of the display; and an inner bracket which includes a metal material, which is coupled to the outer frame, and on which the display and the inner constituent elements of the electronic device are mounted. The polymer material includes a new polycarbonate polymer, a recycled polycarbonate polymer, a phosphite-based additive and an acrylic copolymer.

This application is a continuation application, claiming priority under § 365(c), of an International application No. PCT/KR2024/095252, filed on Feb. 16, 2024, which is based on and claims the benefit of Korean Patent Application No. 10-2023-0021006 filed in the Korean Intellectual Property Office on Feb. 16, 2023, the disclosure of each of which is incorporated by reference herein in its entirety.

### BACKGROUND

### Technical Field

An embodiment disclosed herein relate to an electronic device including a display and a housing, and a housing for an electronic device including a display and internal components. The housing includes a recycled polymer.

### Background Art

Polymers are used in various fields due to the low cost and the good processability and physical properties. Polymers are used in the exterior parts of electronic device housings of electronic devices due to their good mechanical properties, non-conductivity, electromagnetic transparency, and good appearance resulting from the strong affinity with paint. Polycarbonate-based polymers are particularly suitable for the fields described above due to their high tensile strength and impact strength and easy of molding.

Polymer waste may be generated during the manufacturing process and at the end of the service life of polymer products. When such polymer waste is incinerated, landfilled, or dumped, it may cause air pollution, soil contamination, and marine plastic pollution. Accordingly, the polymer scrap and waste described above may be collected and recycled by being introduced as raw materials in the manufacturing of polymer products.

### SUMMARY

### Solution to Problem

During the manufacturing of a polymer product containing recycled polycarbonate, appearance defects may occur due to a decrease in resin melt viscosity or gas generation, and physical properties such as tensile strength and/or impact strength of the manufactured molded product may deteriorate. In addition, polymer products containing recycled polycarbonate may have deteriorated appearance and reduced waterproof performance due to cracks formed during a painting process or a welding process. The cause of such deterioration may be molecular structure changes in the recycled polyamide, such as shortening of the polymer chains and an increased proportion of terminal hydroxyl groups, resulting from thermal decomposition due to heat cycles during product manufacturing, hydrolysis caused by moisture exposure after manufacturing, and degradation due to ultraviolet exposure.

An embodiment disclosed in this document may provide an electronic device housing including a polymer material having improved durability and appearance, while recycling polycarbonate waste.

An embodiment of the disclosure provides an electronic device including a display and a housing, wherein the housing includes an outer frame including a polymer material, where the outer frame configures at least a part of an outer surface of the housing, and is positioned to at least partially protect an outer perimeter of the display, and an inner bracket including a metal material, wherein the inner bracket is coupled to the outer frame, and the display and internal components of the electronic device are mounted on the inner bracket. The polymer material includes a virgin polycarbonate polymer, a recycled polycarbonate polymer, a phosphite-based additive, and an acrylic copolymer.

In an embodiment, the recycled polycarbonate polymer may have a terminal hydroxyl group content of 5 to 90 mole percent (mol %).

In an embodiment, the polymer material may include 10 to 90 weight percent (wt %) of the recycled polycarbonate polymer.

In an embodiment, the polymer material may include 0.1 to 0.4 wt % of the phosphite-based additive.

In an embodiment, the polymer material may include 1 to 5 wt % of the acrylic copolymer.

In an embodiment, the content ratio of the phosphite-based additive to the acrylic copolymer may be 1:10 to 1:50 by weight.

In an embodiment, the housing may include an inorganic filler including a glass fiber, where the inorganic filler is incorporated into the polymer material at a weight ratio of 100:7 to 100:20.

In an embodiment, the virgin polycarbonate polymer may contain 5 wt % or more of a siloxane-based copolymer polycarbonate.

In an embodiment, the outer frame may include a paint layer applied to a region exposed to the outside of the electronic device.

An embodiment of the disclosure provides a housing of an electronic device including a display and an internal component, wherein the housing includes an outer frame including a polymer material, where the outer frame configures at least a part of an outer surface of the housing, and is positioned to at least partially protect an outer perimeter of the display, and
an inner bracket including a metal material, where the inner bracket is coupled to the outer frame, and the display and the internal component are mounted on the inner bracket. The polymer material includes a virgin polycarbonate polymer, a recycled polycarbonate polymer, a phosphite-based additive, and an acrylic copolymer.

In an embodiment, the recycled polycarbonate polymer may have a terminal hydroxyl group content of 5 to 90 mol %.

In an embodiment, the polymer material may include 10 to 90 wt % of the recycled polycarbonate polymer.

In an embodiment, the polymer material may include 0.1 to 0.4 wt % of the phosphite-based additive.

In an embodiment, the polymer material may include 1 to 5 wt % of the acrylic copolymer.

In an embodiment, the content ratio of the phosphite-based additive to the acrylic-based copolymer may be 1:10 to 1:50 by weight.

In an embodiment, the housing may include an inorganic filler including glass fibers, where the inorganic filler is incorporated into the polymer material at a weight ratio of 100:7 to 100:20.

In an embodiment, the virgin polycarbonate polymer may include 5 wt % or more of a siloxane-based copolymer polycarbonate.

In an embodiment, the outer frame may include a paint layer applied on a region exposed to the outside of the electronic device.

According to an embodiment of the disclosure, the polymer mixed with the recycled polycarbonate exhibit improved properties such as strength, impact resistance, surface quality, and chemical resistance, and thus become suitable for use in electronic device housings, thereby reducing generation of plastic waste.

### BRIEF DESCRIPTION OF DRAWINGS

FIG. 1 is a block diagram of an electronic device in a network environment according to an embodiment.

FIG. 2A is a front perspective view of an electronic device according to an embodiment.

FIG. 2B is a rear perspective view of an electronic device according to an embodiment.

FIG. 2C is an exploded perspective view of an electronic device according to an embodiment.

FIG. 3A is a plan view showing the front surface of an electronic device according to an embodiment.

FIG. 3B is a plan view showing a housing of an electronic device according to an embodiment.

FIG. 3C is a cross-sectional view of an electronic device according to an embodiment.

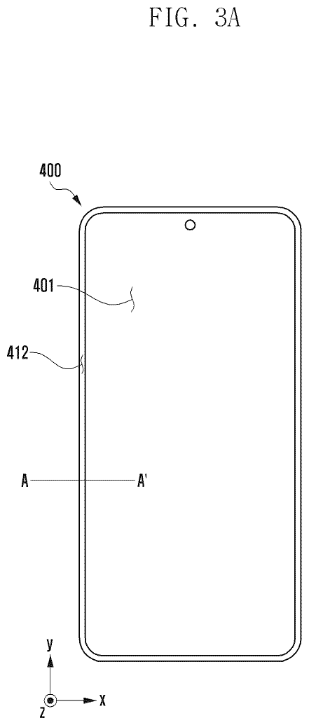

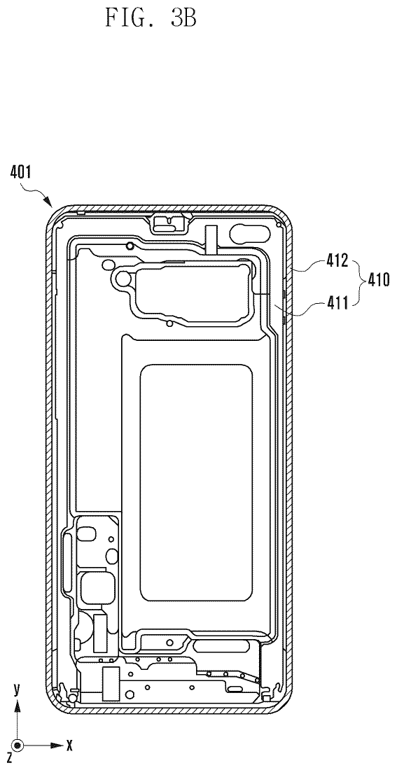

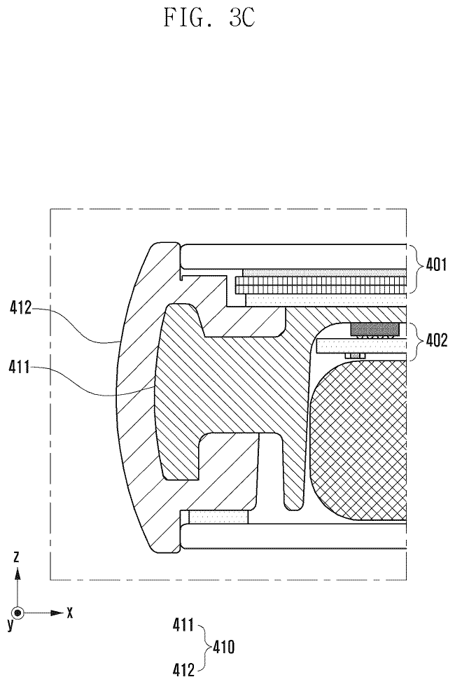

The cross-section of FIG. 3C is a cut section taken along line A-A′ of FIG. 3A.

### DETAILED DESCRIPTION

Hereinafter, exemplary embodiments of the disclosure will be described in detail in conjunction with the accompanying drawings. In the drawings, for example, the sizes and shapes of members may be exaggerated for the sake of descriptive convenience and clarity, and when actually implemented, the illustrated shapes may be modified. Therefore, embodiments of the disclosure is not limited by the particular shapes of areas shown in the specification.

Throughout the specification, the same or like reference signs designate the same or like elements. As used in the specification, the term “and/or” includes any one or all possible combinations of one or more items enumerated together.

Embodiments of the disclosure are provided to more completely explain the disclosure to those skilled in the art to which the disclosure pertains, various changes and modification in form may be made to the embodiments as described below, and the scope of the disclosure is not limited thereto. Instead, the embodiments are provided to make the disclosure more complete and perfect and completely transfer the idea of the disclosure to those skilled in the art.

The terms used in the specification are used to describe embodiments, and are not intended to limit the scope of the disclosure. Although expressed in a singular form, the singular form may include a plural form unless definitely indicated in the context. As used herein, the term “comprise” or “comprising” is intended to specify the existence of mentioned shapes, numbers, steps, operations, elements, components, and/or groups thereof, and does not preclude the possible existence or addition of other shapes, numbers, steps, operations, elements, components, and/or groups thereof.

As used herein, “virgin polycarbonate polymer” refers to polycarbonate resin obtained directly from polymerization of monomers, which has not been previously subjected to use, recycling, or reprocessing.

As used herein, “recycled polycarbonate polymer” refers to polycarbonate material derived from post-consumer or post-industrial sources, which has undergone at least one recycling process, such as mechanical grinding and re-melting, chemical depolymerization, or solvent purification, to render it suitable for reuse in polymer blends or molded articles.

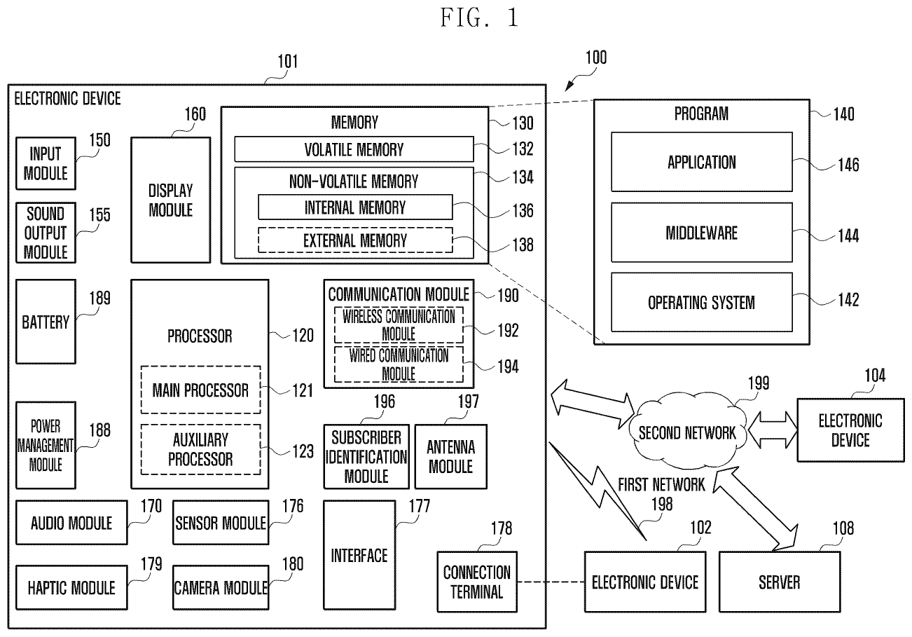

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one of the components (e.g., the connecting terminal 178) may be omitted from the electronic device 101, or one or more other components may be added in the electronic device 101. In an embodiment, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic devices according to an embodiment disclosed herein may be devices of various forms. The electronic devices may include, for example, portable communication devices (e.g., smartphones), computer devices, portable multimedia devices, portable medical devices, cameras, wearable devices, or home appliance devices. The electronic devices according to embodiments of this document are not limited to the devices described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in an embodiment of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

An embodiment as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each element (e.g., a module or a program) of the above-described elements may include a single entity or multiple entities, and some of the multiple entities may be separately disposed in another element. According to an embodiment, one or more of the above-described elements or operations may be omitted, or one or more other elements or operations may be added. Alternatively or additionally, a plurality of elements (e.g., modules or programs) may be integrated into a single element. In such a case, according to an embodiment, the integrated element may still perform one or more functions of each of the plurality of elements in the same or similar manner as they are performed by a corresponding one of the plurality of elements before the integration. According to an embodiment, operations performed by the module, the program, or another element may be carried out sequentially, in parallel, repeatedly, or heuristically, or one or more of the operations may be executed in a different order or omitted, or one or more other operations may be added.

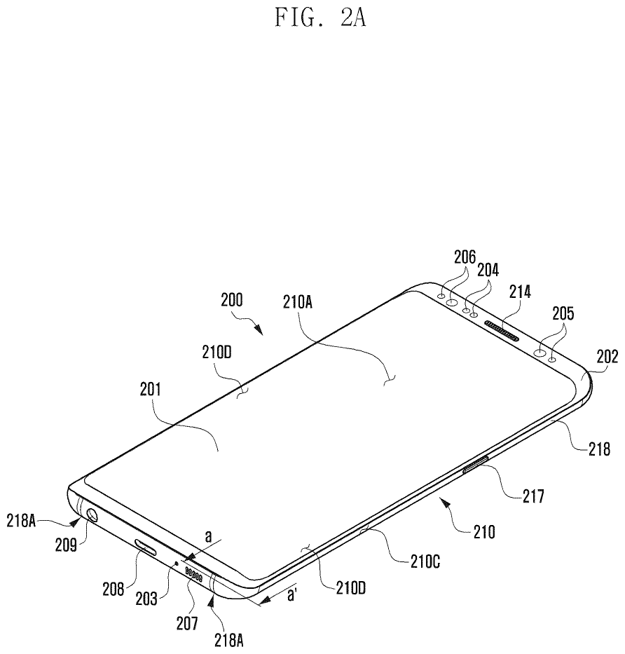

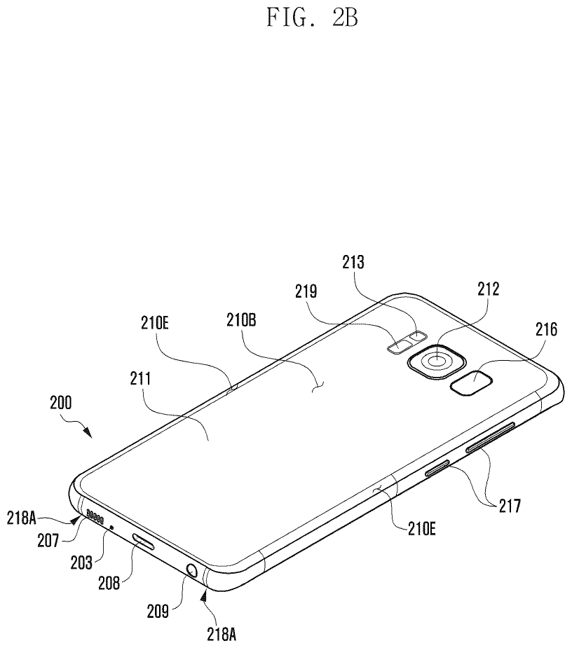

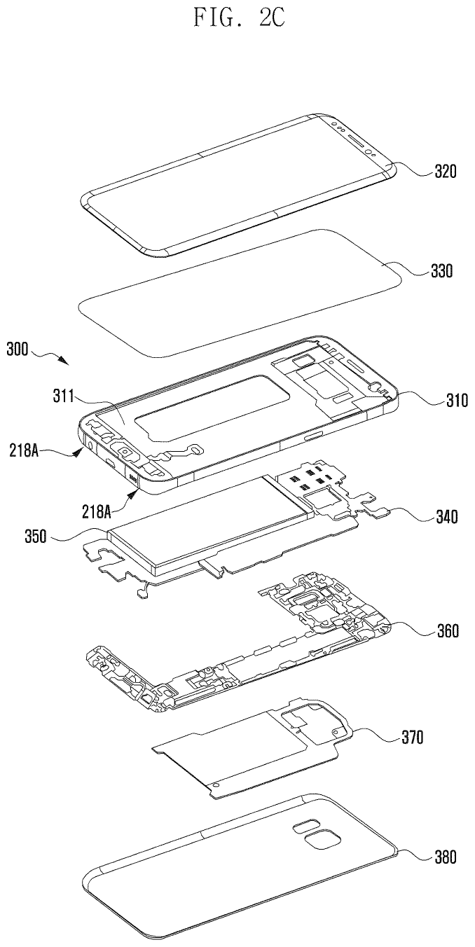

FIG. 2a illustrates a perspective view showing a front surface of a mobile electronic device 300 according to an embodiment, and FIG. 2b illustrates a perspective view showing a rear surface of the mobile electronic device 300 shown in FIG. 2a.

The electronic device 300 of FIGS. 2a and 2b may be at least partially similar to the electronic device 101 of FIG. 1 or may include other embodiments of the electronic device.

Referring to FIGS. 2a and 2b, the mobile electronic device 200 may include a housing 210 that includes a first surface (or front surface) 210A, a second surface (or rear surface) 210B, and a lateral surface 210C that surrounds a space between the first surface 210A and the second surface 210B. The housing 210 may refer to a structure that forms a part of the first surface 210A, the second surface 210B, and the lateral surface 210C. The first surface 210A may be formed of a front plate 202 (e.g., a glass plate or polymer plate coated with a variety of coating layers) at least a part of which is substantially transparent. The second surface 210B may be formed of a rear plate 211 which is substantially opaque. The rear plate 211 may be formed of, for example, coated or colored glass, ceramic, polymer, metal (e.g., aluminum, stainless steel (STS), or magnesium), or any combination thereof. The lateral surface 210C may be formed of a lateral bezel structure (or “lateral member”) 220 which is combined with the front plate 202 and the rear plate 211 and includes a metal and/or polymer. The rear plate 211 and the lateral bezel structure 220 may be integrally formed and may be of the same material (e.g., a metallic material such as aluminum).

The front plate 202 may include two first regions 210D disposed at long edges thereof, respectively, and bent and extended seamlessly from the first surface 210A toward the rear plate 211. Similarly, the rear plate 211 may include two second regions 210E disposed at long edges thereof, respectively, and bent and extended seamlessly from the second surface 210B toward the front plate 202. The front plate 202 (or the rear plate 211) may include only one of the first regions 210D (or of the second regions 210E). The first regions 210D or the second regions 310E may be omitted in part. When viewed from a lateral side of the mobile electronic device 200, the lateral bezel structure 220 may have a first thickness (or width) on a lateral side where the first region 210D or the second region 210E is not included, and may have a second thickness, being less than the first thickness, on another lateral side where the first region 210D or the second region 210E is included.

The mobile electronic device 200 may include at least one of a display 201, audio modules 203, 207 and 214, sensor modules 204 and 219, camera modules 205, 212 and 213, a key input device 217, a light emitting device, and connector holes 208 and 209. The mobile electronic device 200 may omit at least one (e.g., the key input device 217 or the light emitting device) of the above components, or may further include other components.

The display 201 may be exposed through a substantial portion of the front plate 202, for example. At least a part of the display 201 may be exposed through the front plate 302 that forms the first surface 210A and the first region 210D of the lateral surface 210C. Outlines (i.e., edges and corners) of the display 201 may have substantially the same form as those of the front plate 202. The spacing between the outline of the display 201 and the outline of the front plate 202 may be substantially unchanged in order to enlarge the exposed area of the display 201. A recess or opening may be formed in a portion of a display area of the display 201 to accommodate at least one of the audio module 214, the sensor module 204, the camera module 205, and the light emitting device. At least one of the audio module 214, the sensor module 204, the camera module 205, the fingerprint sensor (not shown), and the light emitting element may be disposed on the back of the display area of the display 201. The display 201 may be combined with, or adjacent to, a touch sensing circuit, a pressure sensor capable of measuring the touch strength (pressure), and/or a digitizer for detecting a stylus pen. At least a part of the sensor modules 204 and 219 and/or at least a part of the key input device 217 may be disposed in the first region 210D and/or the second region 210E.

The audio modules 203, 207 and 214 may correspond to a microphone hole 203 and speaker holes 207 and 214, respectively. The microphone hole 203 may contain a microphone disposed therein for acquiring external sounds and, in a case, contain a plurality of microphones to sense a sound direction. The speaker holes 207 and 214 may be classified into an external speaker hole 207 and a call receiver hole 214. The microphone hole 203 and the speaker holes 207 and 314 may be implemented as a single hole, or a speaker (e.g., a piezo speaker) may be provided without the speaker holes 207 and 214.

The sensor modules 204 and 219 may generate electrical signals or data corresponding to an internal operating state of the mobile electronic device 200 or to an external environmental condition. The sensor modules 204 and 219 may include a first sensor module 204 (e.g., a proximity sensor) and/or a second sensor module (e.g., a fingerprint sensor) disposed on the first surface 210A of the housing 210, and/or a third sensor module 219 (e.g., a heart rate monitor (HRM) sensor) and/or a fourth sensor module (e.g., a fingerprint sensor) disposed on the second surface 210B of the housing 210. The fingerprint sensor may be disposed on the second surface 210B as well as the first surface 210A (e.g., the display 201) of the housing 210. The electronic device 200 may further include at least one of a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules 205, 212 and 213 may include a first camera device 205 disposed on the first surface 210A of the electronic device 200, and a second camera device 312 and/or a flash 213 disposed on the second surface 210B. The camera module 205 or the camera module 212 may include one or more lenses, an image sensor, and/or an image signal processor. The flash 213 may include, for example, a light emitting diode or a xenon lamp. Two or more lenses (infrared cameras, wide angle and telephoto lenses) and image sensors may be disposed on one side of the electronic device 300.

The key input device 217 may be disposed on the lateral surface 210C of the housing 210. The mobile electronic device 200 may not include some or all of the key input device 217 described above, and the key input device 217 which is not included may be implemented in another form such as a soft key on the display 201. The key input device 217 may include the sensor module disposed on the second surface 210B of the housing 210.

The light emitting device may be disposed on the first surface 210A of the housing 210. For example, the light emitting device may provide status information of the electronic device 200 in an optical form. The light emitting device may provide a light source associated with the operation of the camera module 205. The light emitting device may include, for example, a light emitting diode (LED), an IR LED, or a xenon lamp.

The connector holes 208 and 209 may include a first connector hole 208 adapted for a connector (e.g., a USB connector) for transmitting and receiving power and/or data to and from an external electronic device, and/or a second connector hole 309 adapted for a connector (e.g., an earphone jack) for transmitting and receiving an audio signal to and from an external electronic device.

FIG. 2C is an exploded perspective view of an electronic device according to an embodiment of the present invention.

Referring to FIG. 2C, the mobile electronic device 300 may include a lateral bezel structure 310, a first support member 3211 (e.g., a bracket), a front plate 302, a display 301, an electromagnetic induction panel, a PCB 340, a battery 350, a second support member 360 (e.g., a rear case), an antenna 370, and a rear plate 311. The mobile electronic device 300 may omit at least one (e.g., the first support member 3211 or the second support member 360) of the above components or may further include another component. Some components of the electronic device 300 may be the same as or similar to those of the mobile electronic device 300 shown in FIG. 2a or FIG. 2b, thus, descriptions thereof are omitted below.

The first support member 311 is disposed inside the mobile electronic device 300 and may be connected to, or integrated with, the lateral bezel structure 310. The first support member 3211 may be formed of, for example, a metallic material and/or a non-metal (e.g., polymer) material. The first support member 311 may be combined with the display 301 at one side thereof and also combined with the PCB 340 at the other side thereof. On the PCB 340, a processor, a memory, and/or an interface may be mounted. The processor may include, for example, one or more of a CPU, an AP, a GPU, an ISP, a sensor hub processor, or a CP.

One surface of the display 330 may be located on the rear surface of the front plate 320, and the other surface may be coupled to the housing 310. In an embodiment, the display 330 and the front plate 320 may be referred to as a display module in a coupled state to each other.

The memory may include, for example, volatile memory or non-volatile memory.

The interface may include, for example, a high definition multimedia interface (HDMI), a USB interface, a secure digital (SD) card interface, and/or an audio interface. The interface may electrically or physically connect the mobile electronic device 300 with an external electronic device and may include a USB connector, an SD card/multimedia card (MMC) connector, or an audio connector.

The battery 350 is a device for supplying power to at least one component of the mobile electronic device 300, and may include, for example, a non-rechargeable primary battery, a rechargeable secondary battery, or a fuel cell. At least a part of the battery 350 may be disposed on substantially the same plane as the PCB 340. The battery 350 may be integrally disposed within the mobile electronic device 300, and may be detachably disposed from the mobile electronic device 300.

The antenna 370 may be disposed between the rear plate 311 and the battery 350. The antenna 370 may include, for example, a near field communication (NFC) antenna, a wireless charging antenna, and/or a magnetic secure transmission (MST) antenna. The antenna 370 may perform short-range communication with an external device, or transmit and receive power required for charging wirelessly. An antenna structure may be formed by a part or combination of the lateral bezel structure 310 and/or the first support member 311.

FIG. 3A is a plan view showing the front surface of an electronic device 400 according to an embodiment.

FIG. 3B is a plan view showing a housing 410 of the electronic device 400 according to an embodiment.

FIG. 3C is a cross-sectional view of the electronic device 400 according to an embodiment.

The cross-section of FIG. 3C is a cut section taken along line A-A′ of FIG. 3A.

Referring to FIGS. 3A to 3C, the electronic device 400 may include a display 401 and a housing 410. The housing 410 may include an outer frame 412 (e.g., the housing 410 or 310 of FIG. 2C) and an inner bracket 411 (e.g., the first support member 311 of FIG. 2C). The outer frame 412 may include a part of the housing 410 that is exposed to an outer surface of the electronic device 400. The outer frame 412 may be positioned to at least partially protect an outer perimeter of the display 401 and surround a lateral surface of the electronic device. The inner bracket 411 may be a member that is coupled to the outer frame 412 to support the outer frame 412 and provides a space in which an internal component (e.g., a substrate 402) of the electronic device 400 is mounted and fixed.

In an embodiment, the inner bracket 411 may include a metal material. The metal material may include, for example, an aluminum alloy, a magnesium alloy, and stainless steel. The metal material of the inner bracket 411 may reinforce the rigidity and strength of the housing 410 and may act as an antenna for transmitting and receiving radio waves. In an embodiment, the outer frame 412 may include a polymer material. The polymer material may include, for example, a polycarbonate material. In an embodiment, the outer frame 412 may be coated with various paint layers that protect the surface of the outer frame 412 and enhance the appearance of the electronic device 400. In an embodiment, the outer frame 412 may be configured by insert injection. For example, the outer frame 412 may be coupled to the inner bracket 411 by injection molding a polycarbonate resin into a mold while the inner bracket 411 is inserted into the mold.

The polymer material of the outer frame 412 according to an embodiment of the disclosure may include a virgin polycarbonate polymer, a recycled polycarbonate polymer, a phosphite-based additive, and an acrylic copolymer. The polycarbonate may be a homopolymer and/or copolymer having a repeating structure as shown in Chemical Formula 1 below, which is manufactured through a reaction between a diol compound and a precursor such as phosgene, a halogenated formate, or a carbonic diester:

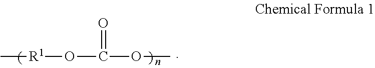

R1 in Chemical Formula 1 may be at least partially aromatic. For example, R1 may include various aromatic dihydroxy compounds such as bisphenol or derivatives thereof.

In an embodiment, the average molecular weight of the virgin polycarbonate polymer molecules may be 20,000 to 50,000 grams per mole (g/mol). The average molecular weight of the recycled polycarbonate polymer may be lower due to deterioration during the manufacturing and use processes. For example, the average molecular weight of the recycled polycarbonate polymer may be 15,000 to 50,000 g/mol.

In an embodiment, the polymer material may contain 10 to 90 wt % of the recycled polycarbonate polymer. When the content of the recycled polycarbonate polymer exceeds 90 wt %, the likelihood of defects such as carbonization and/or gas generation during injection molding of the polymer material may become excessively high, and the chemical resistance may be reduced, so that the strength and impact resistance may be reduced when paint and/or coating is applied.

The phosphite-based additive may be a compound including at least one phosphorous acid group in Chemical Formula 2 below:

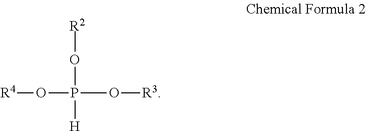

R2, R3 and R4 of Chemical Formula 2 above may each independently be hydrogen, an aliphatic and/or aromatic functional group, and at least some of the hydrogen atoms thereof may be substituted with halogen. For example, the phosphite-based additive may include Bis (2,4-dicumylphenyl) pentaerythritol diphosphate of Chemical Formula 3 below:

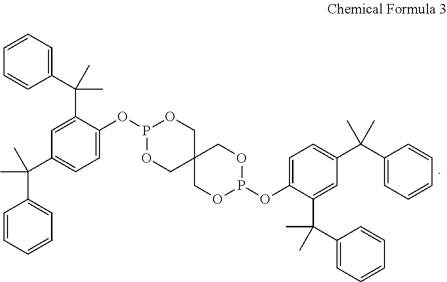 [SMILES: CC(C)(c1ccccc1)c1ccc(OP2OCC3(CO2)COP(Oc2ccc(C(C)(C)c4ccccc4)cc2C(C)(C)c2ccccc2)OC3)c(C(C)(C)c2ccccc2)c1]

The phosphite-based additive may improve the fluidity of the polycarbonate polymer in a molten state. In addition, the phosphite-based additive may improve the wettability of the polymer material with respect to inorganic fillers added to the polymer, such as reinforcing materials including glass fibers, thereby preventing and/or reducing appearance defects, such as surface protrusion of an injection-molded product of glass fibers, occurring during injection molding.

In an embodiment, the polymer material may contain 0.1 to 0.4 wt % of a phosphite-based additive. When the content of the phosphite-based additive is less than 0.1 wt %, the fluidity of the polymer material in a molten state and the wettability with respect to the inorganic filler are excessively reduced, and when the content of the phosphite-based additive exceeds 0.4 wt %, the fluidity of the polymer may become excessively high, which may cause burr formation in the injection-molded product or significantly delay the solidification rate of the injection-molded product.

The acrylic copolymer may be a copolymer including an acrylic acid ester, such as Chemical Formula 4 below:

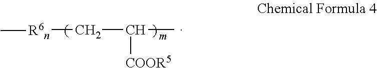

In Chemical Formula 4, R5 is an alkyl group and/or an aromatic compound, and R6 may be a polymer monomer such as an olefin, methacrylate, arylate, acrylonitrile, and/or ester. For example, the acrylic copolymer may include an ethylene methyl acrylate copolymer (EMA) represented by Chemical Formula 5 below:

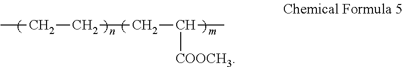

Acrylic copolymers may have highly compatibility with polycarbonate and may combine with recycled polycarbonate polymers to extend polymer chain. Therefore, polymer materials including acrylic copolymers and recycled polycarbonate polymers may have improved strength, impact resistance, chemical resistance, and compatibility with paint.

Recycled polycarbonate polymers may be degraded by various physical and/or chemical processes during production, use, and disposal. Degraded polycarbonate polymer molecules may exhibit reduced strength, hardness, and weldability. For example, polycarbonate polymer molecules may be degraded through hydrolysis, as shown in Chemical Formula 6:

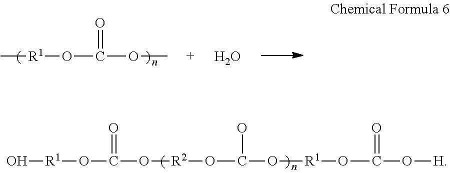

As seen above, the recycled polycarbonate polymer molecule that has undergone a degradation process may contain a hydroxyl group (—OH) at the terminal. For example, the recycled polycarbonate polymer may contain 5 to 90 mol % of the terminal hydroxyl group. The hydroxyl group has high affinity for chemical substances (e.g., solvents such as water, alcohol, acetone, and thinner), and thus, a high content of the hydroxyl group may result in reduced chemical resistance and increased possibility of crack formation during painting and/or coating. According to an embodiment of the disclosure, the reduced chemical resistance due to the terminal hydroxyl group may be prevented and/or minimized by mixing and combining the acrylic copolymer with the recycled polycarbonate.

In an embodiment, the polymer material may include 1 to 5 wt % of the acrylic copolymer. When the content of the acrylic copolymer is less than 1 wt %, the chemical resistance of the polymer material may be reduced, and when the content of the acrylic copolymer exceeds 5 wt %, the fluidity of the polymer material in a molten state may be excessively reduced by the acrylic copolymer.

In an embodiment, the polymer material may include the phosphite-based additive and the acrylic copolymer in a weight ratio of 1:10 to 1:50. As described above, the phosphite-based additive and the acrylic copolymer may be antagonistic to each other in terms of the fluidity of the polymer material in a molten state. Thus, when the ratio falls outside the range above, the fluidity of the polymer material may not be suitable for the injection molding process.

According to an embodiment, the outer frame 412 of the housing 410 may include an inorganic filler. The inorganic filler may be incorporated into the polymer material to mechanically strengthen the polymer material and control the density thereof. In an embodiment, the inorganic filler may include fibrous or acicular inorganic materials such as glass fiber, carbon fiber, mineral wool, or wollastonite. In other embodiments, the inorganic filler may include a granular or plate-like solid inorganic material, such as talc, clay, kaolin, mica, or calcium carbonate.

In an embodiment, the outer frame 412 may include 7 to 20 parts by weight of the inorganic filler, based on 100 parts by weight of the polymer material. When the content of the inorganic filler is within the range above, the mechanical properties of the polymer material may be improved.

In an embodiment, the particle shape of the inorganic filler may have a ratio of the short axis to the long axis of 1:1 to 1:10, specifically, 1:2 to 1:8. In an embodiment, the length of the inorganic filler may be 1 to 5 millimeters (mm), specifically, 2 to 4 mm. When the length of the inorganic filler is shorter than the range above, the reinforcing effect of the polymer by the inorganic filler is reduced. In addition, when the length of the inorganic filler exceeds the range above, the integration between the polyamide and the inorganic filler may become incomplete, or entanglement between the inorganic fillers may cause the inorganic fillers to agglomerate in certain regions of the injection-molded product.

In an embodiment, the polymer material may include a siloxane-based copolymer polycarbonate. The siloxane-based copolymer polycarbonate may be a polycarbonate in which a siloxane monomer such as that represented by Chemical Formula 7 below is copolymerized:

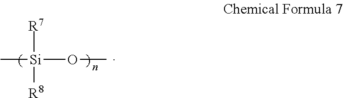

In Chemical Formula 7 above, R7 and R8 may each independently include hydrogen, an alkyl group, an aromatic compound, and/or at least some of the hydrogen atoms thereof are substituted with halogen. The siloxane-based copolymer polycarbonate may be included in an amount of 5 to 100 parts by weight, based on 100 parts by weight of the polymer material.

In an embodiment, the polymer material of the disclosure may further include additives as needed within a range that does not impede the effects of the disclosure, in addition to the components described above. The additives may include, but are not necessarily limited to, antioxidants, activators, heat stabilizers, flame retardants, weather stabilizers, antistatic agents, release agents, colorants, and mixtures thereof.

To evaluate the effect of polymer materials according to an embodiment of the disclosure, polymer materials of an embodiment including recycled polyamide were prepared and the properties and quality thereof were compared with those of comparative examples. The specific compositions of the examples and comparative examples are described in Table 1. The polymer materials of the examples and comparative examples were prepared by mixing the components listed in Table 1 using a mixer to produce pellets, and then injection molding the pellets to fabricate test specimens.

TABLE 1

| | | | | | Evaluation results | | | |
|---|---|---|---|---|---|---|---|---|
| | | | | | | Drop | | |
| | Composition/Component content | | | | | impact | | |
| | | | Phosphite- | | Thermal | fracture | Chemical | Injection- |
| | Recycled | Virgin | based | Acrylate | shock | height | resistance | molded |
| Section | PC | PC | additive | copolymer | cracking | (cm) | (min) | appearance |
| Example 1 | 22 | 78 | 0.1 | 1 | OK | 32 | 27 | OK |
| Example 2 | 22 | 78 | 0.1 | 5 | OK | 40 | 39 | OK |
| Example 3 | 90 | 10 | 0.2 | 4 | OK | 38 | 40 | OK |
| Example 4 | 10 | 90 | 0.2 | 4 | OK | 43 | 42 | OK |
| Example 1 | 22 | 78 | 0.2 | 0.4 | NG | 15 | 19 | OK |
| Example 2 | 22 | 78 | 0.2 | 6 | OK | 29 | 32 | NG |
| Example 3 | 22 | 78 | 0.05 | 4 | NG | 25 | 18 | NG |
| Example 4 | 22 | 78 | 0.6 | 4 | NG | 38 | 26 | NG |
| Example 5 | 100 | 0 | 0.2 | 4 | OK | 28 | 15 | NG |

* PC stands for polycarbonate.

Table 1 above, the unit for component content is weight percent (wt %). The PC stands for polycarbonate. Referring to Table 1, the polymer material according to the embodiments of the disclosure did not develop cracks even after repeated thermal cycles, and was not damaged by a falling weight dropped from a height of less than 32 to 43 centimeters (cm) with a coating applied, indicating relatively good impact and chemical resistance. In addition, when subjected to tensile deformation, cracks appeared after 27 to 42 minutes of contact with cosmetics, demonstrating relatively good chemical resistance. Furthermore, no defects such as gas generation or surface delamination occurred during injection molding.

In contrast, the polymer material according to the comparative examples exhibited generally lower impact resistance, with breakage occurring at a drop height of 15 to 32 cm in the falling weight test, and cracks forming after a relatively short period of contact with cosmetics. In addition, Comparative Example 1, in which the content of the acrylate copolymer was excessively low, developed cracks during repeated thermal cycle testing. Comparative Examples 3 and 4, in which the content of the phosphite-based additive was either excessively low or high, showed surface cracks and delamination.

As noted from the results described above, the polymer material according to the embodiments of the disclosure has the strength, impact resistance, surface quality, and chemical resistance required for the material of the outer frame 412 configuring the exterior of the housing 410 of the electronic device 400. Therefore, according to the embodiments of the disclosure, during the manufacturing of the housing 410 of the electronic device 400, it is possible to use a polymer material mixed with recycled polycarbonate, thereby reducing the generation of polycarbonate plastic waste.

According to an embodiment of the disclosure, the electronic device 400 may include a display 401 and a housing 410, wherein the housing 410 includes an outer frame 412 which includes a polymer material, and the outer frame 412 configures at least a part of an outer surface of the housing 410, and is positioned to at least partially protect an outer perimeter of the display 401. The electronic device 400 may include an inner bracket 411 including a metal material, where the inner bracket is coupled to the outer frame 412, and the display 401 and an internal component of the electronic device 400 are mounted on the inner bracket. The polymer material may include a virgin polycarbonate polymer, a recycled polycarbonate polymer, a phosphite-based additive, and an acrylic copolymer.

In an embodiment, the recycled polycarbonate polymer may have a terminal hydroxyl group content of 5 to 90 mol %.

In an embodiment, the polymer material may include 10 to 90 wt % of the recycled polycarbonate polymer.

In an embodiment, the polymer material may include 0.1 to 0.4 wt % of the phosphite-based additive.

In an embodiment, the polymer material may include 1 to 5 wt % of the acrylic copolymer.

In an embodiment, the content ratio of the phosphite-based additive to the acrylic copolymer may be 1:10 to 1:50 by weight.

In an embodiment, the housing 410 may include an inorganic filler incorporated into the polymer material at a weight ratio of 100:7 to 100:20.

In an embodiment, the inorganic filler may include glass fibers.

In an embodiment, the virgin polycarbonate polymer may include 5 wt % or more of a siloxane-based copolymer polycarbonate.

In an embodiment, the outer frame 412 may include a paint layer applied on a region exposed to the outside of the electronic device 400.

According to an embodiment of the disclosure, the housing 410 of the electronic device 400 may include the display 401 and an internal component. The housing 410 of the electronic device 400 includes the outer frame 412 including a polymer material, where the outer frame configures at least a part of an outer surface of the housing 410, and is positioned to at least partially protect an external perimeter of the display 401. The housing 410 may include the inner bracket 411 including a metal material, where the inner bracket is coupled to the outer frame 412, and the display 401 and the internal component are mounted on the inner bracket. The polymer material may include a virgin polycarbonate polymer, a recycled polycarbonate polymer, a phosphite-based additive, and an acrylic copolymer.

In an embodiment, the recycled polycarbonate polymer may have a terminal hydroxyl group content of 5 to 90 mol %.

In an embodiment, the polymer material may include 10 to 90 wt % of the recycled polycarbonate polymer.

In an embodiment, the polymer material may include 0.1 to 0.4 wt % of the phosphite-based additive.

In an embodiment, the polymer material may include 1 to 5 wt % of the acrylic copolymer.

In an embodiment, the content ratio of the phosphite-based additive to the acrylic copolymer may be 1:10 to 1:50 by weight.

In an embodiment, the housing 410 may include an inorganic filler incorporated into the polymer material at a weight ratio of 100:7 to 100:20.

In an embodiment, the inorganic filler may include glass fibers.

In an embodiment, the novel polycarbonate polymer may include least 5 wt % or more of a siloxane-based copolymer polycarbonate.

In an embodiment, the outer frame 412 may include a paint layer applied on a region exposed to the outside of the electronic device 400.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. Therefore, the scope of an embodiment of the disclosure should be construed to include, in addition to the embodiments set forth herein, all changes and modifications derived based on the technical idea of an embodiment of the disclosure.

1. An electronic device comprising a display and a housing,
wherein the housing comprises:
an outer frame comprising a polymer material, wherein the outer frame configures at least a part of an outer surface of the housing, and is positioned to at least partially protect an outer perimeter of the display; and
an inner bracket comprising a metal material, wherein the inner bracket is coupled to the outer frame, and the display and internal components of the electronic device are mounted on the inner bracket, and
wherein the polymer material comprises:
a virgin polycarbonate polymer;
a recycled polycarbonate polymer which has been degraded by at least one of physical or chemical processes during its production, use, or disposal;
a phosphite-based additive; and
an acrylic copolymer.

2. The electronic device of claim 1, wherein the recycled polycarbonate polymer has a terminal hydroxyl group content of 5 to 90 mole percent.

3. The electronic device of claim 1, wherein the polymer material comprises 10 to 90 weight percent of the recycled polycarbonate polymer.

4. The electronic device of claim 1, wherein the polymer material comprises 0.1 to 0.4 weight percent of the phosphite-based additive.

5. The electronic device of claim 1, wherein the polymer material contains 1 to 5% by weight of the acrylic copolymer.

6. The electronic device of claim 1, wherein a content ratio of the phosphite-based additive to the acrylic copolymer is 1:10 to 1:50 by weight.

7. The electronic device of claim 1, wherein the housing comprises an inorganic filler comprising a glass fiber, wherein the inorganic filler is incorporated into the polymer material at a weight ratio of 100:7 to 100:20.

8. The electronic device of claim 7, wherein the inorganic filler comprises glass fibers.

9. The electronic device of claim 1, wherein the virgin polycarbonate polymer comprises 5 weight percent or more of a siloxane-based copolymer polycarbonate.

10. The electronic device of claim 1, wherein the outer frame comprises a paint layer applied on a region exposed to an outside of the electronic device.

11. A housing of an electronic device comprising a display and internal components, the housing comprising:
an outer frame comprising a polymer material, wherein the outer frame configures at least a part of an outer surface of the housing, and is positioned to at least partially protect an outer perimeter of the display; and
an inner bracket comprising a metal material, wherein the inner bracket is coupled to the outer frame, and the display and the internal components of the electronic device are mounted on the inner bracket,
wherein the polymer material comprises:
a virgin polycarbonate polymer;
a recycled polycarbonate polymer;
a phosphite-based additive; and
an acrylic copolymer.

12. The housing of claim 11, wherein the recycled polycarbonate polymer has a terminal hydroxyl group content of 5 to 90 mole percent.

13. The housing of claim 11, wherein the polymer material comprises 10 to 90 weight percent of the recycled polycarbonate polymer.

14. The housing of claim 11, wherein the polymer material comprises 0.1 to 0.4 weight percent of the phosphite-based additive, and 1 to 5 weight percent of the acrylic copolymer.

15. The housing of claim 1, wherein the polymer material comprises 1 to 5 wt % of the acrylic copolymer.

16. The housing of claim 11, wherein a content ratio of the phosphite-based additive to the acrylic copolymer is 1:10 to 1:50 by weight.

17. The housing of claim 9, wherein the housing comprises an inorganic filler comprising a glass fiber, wherein the inorganic filler is incorporated into the polymer material at a weight ratio of 100:7 to 100:20.

18. The housing of claim 17, wherein the inorganic filler comprises glass fibers.

19. The housing of claim 11, wherein the virgin polycarbonate polymer comprises 5 weight percent or more of a siloxane-based copolymer polycarbonate.

20. The housing of claim 1, wherein the exterior frame comprises a coating layer applied on a region exposed to the outside of the electronic device.
